(19) United States
(12) Patent Application Publication
(10) Pub. No.: US 2012/0313941 A1
(43) Pub. Date: Dec. 13, 2012

(54) SYSTEM AND METHOD FOR DIGITAL VOLUME PROCESSING

(76) Inventors: Xiaoliang Li, Shanghai (CN); Fan Xu, PuDong (CN); Shoupu Chen, Rochester, NY (US)

(21) Appl. No.: 13/156,378

(22) Filed: Jun. 9, 2011

(51) Int. Cl. G06T 17/00

(52) U.S. Cl. 345/424

(57) ABSTRACT

A method for processing a digital volume image receives the volume image formed as a stack of image slices, each slice containing voxels and forms a 1:1 mapping of each of the slices, in order, to a corresponding tile in a digital flat volume. The method defines, for at least one voxel in a plurality of voxels in the digital flat volume, a neighborhood that includes the at least one voxel and adjacent voxels that are within the corresponding tile of the voxel, and adjacent voxels to the at least one voxel that are within the preceding tile in the digital flat volume, and adjacent voxels to the voxel that are within the next tile in the digital flat volume. The at least one voxel is rendered according to the adjacent voxels in its defined neighborhood. The volume image having the at least one rendered voxel is displayed.

### FIELD OF THE INVENTION

The invention relates generally to processing of digital volume images, and in particular, to a system and methods for improved high-speed processing of digital volume images using a GPU (graphics processing unit).

### BACKGROUND OF THE INVENTION

3-D volume imaging is a diagnostic tool that offers advantages over earlier 2-D radiographic imaging techniques for evaluating the condition of internal structures and organs. 3-D imaging of a patient or other subject has been made possible by a number of advancements, including the development of high-speed imaging detectors, such as digital radiography (DR) detectors that enable multiple images to be taken in rapid succession. Digital volume images, obtained from computerized tomography (CT) or other imaging systems, provide valuable tools for diagnosis, treatment planning, and biomedical modeling and visualization.

While it offers considerable benefits, 3-D volume imaging works with large amounts of data and requires considerable data processing resources, with very high CPU usage and long processing times. Image processing utilities for 3-D volume imaging include processes such as volume segmentation, a process that partitions a three-dimensional image set into a plurality of non-overlap regions. As an example of a segmentation process, the GrowCut segmentation algorithm (see “GrowCut—Interactive Multi-Label N-D Image Segmentation By Cellular Automata,” by Vladimir Vezhnevets, and Fadim Konouchine, International Conf. Computer Graphics and Vision 2005) stores at least five intermediate three-dimensional image sets in order to perform its segmentation. With this much data to process, computation cost is often a concern and the CPU (central processing unit) based GrowCut algorithm takes a very long time to compute. For a medium size volume data set (e.g. 181×147×242 voxels), the execution time using GrowCut segmentation is about one hour using a capable CPU processor (e.g. an Intel® Core™ 2 Duo CPU).

One solution proposed for processing the massive amounts of data needed to support functions such as image segmentation is the use of a dedicated Graphical Processing Unit (GPU). Originally developed for computer game and simulation applications, the GPU has evolved from a dedicated graphic display processor with a fixed pipeline to a more capable processor for general purpose computing, matrix computing, image processing, simulation and medical imaging using parallel processing with the programming pipeline. GPU architecture and its parallel processing capabilities have been utilized for providing hardware-accelerated volume image rendering of CT and other images, as described in U.S. Patent Application No. 2006/0227131 entitled “Flat Texture Volume Rendering” by Schiwietz et al. This approach stores the 3D image slices as flat texture data. While such a method improves some aspects of image storage and addressing, however, it does not facilitate update of the volume image data and makes it cumbersome to apply processing such as bilinear filtering, for example, that require facile computation between neighboring voxels. It is necessary to calculate the tile offsets in the flat volume in order to find neighbors for a voxel. Such calculation can slow the shader performance considerably, since it is required for every voxel in the GPU shader program. Significantly, because of the complexity and time required for addressing neighboring voxels, the method taught in Schiwietz et al. '7131 is not well suited to support segmentation, such as using the GrowCut algorithm noted earlier.

While GPU capabilities offer some promise for improving processing speed and capability overall, a number of significant problems remain. GPU programming is not straightforward and requires different strategies for data storage and addressing than those conventionally applied for central processing unit (CPU) schemes. The graphic pipeline API of the GPU does not directly handle volume imaging structures, but requires re-mapping of image data to existing data structures, which can be time consuming and can make functions such as image filtering more difficult to execute than when using conventional data representation. Even with high level programming languages designed for GPU interaction, such as OpenCL, CUDA, CAL and Brook, careful implementation design is important in order to achieve improvements in volume imaging performance.

Thus it is seen that, while GPU capabilities offer an attractive alternative to conventional CPU-based image processing for volume images, there is considerable work needed to take advantage of GPU speed and parallel processing capabilities. One aspect of this problem relates to the task of mapping the existing volume image data structures into a form that can be readily handled by the GPU and to addressing schemes needed to harness the capability of the GPU for high-level image processing such as registration, filtering, and segmentation.

### SUMMARY OF THE INVENTION

It is an object of the present invention to advance the art of volume image processing using GPU based technology. The present invention provides methods that help to streamline and simplify the problem of voxel addressing needed to obtain information from neighboring voxels for each voxel in a volume image.

An advantage of the present invention relates to the ease of indexing between slices of the image when arranged in a GPU flat volume data structure.

According to an aspect of the present invention, there is provided a method for processing a digital volume image, the method executed at least in part on a computer and comprising: receiving the digital volume image as a stack of image slices, each slice containing a plurality of voxels; forming a 1:1 mapping of each of the slices, in order, to a corresponding tile in a digital flat volume; defining, for at least one voxel in a plurality of voxels in the digital flat volume, a neighborhood that comprises the at least one voxel and adjacent voxels that are within the corresponding tile of the at least one voxel, and adjacent voxels to the at least one voxel that are within the preceding tile in the digital flat volume, and adjacent voxels to the at least one voxel that are within the next tile in the digital flat volume; rendering the at least one voxel according to the adjacent voxels in its defined neighborhood; and displaying the volume image having the at least one rendered voxel.

### BRIEF DESCRIPTION OF THE DRAWINGS

The foregoing and other objects, features, and advantages of the invention will be apparent from the following more particular description of the embodiments of the invention, as illustrated in the accompanying drawings, in which:

FIG. 1A is a schematic diagram that shows a pixel and its neighbors in a 2-dimensional image arrangement.

FIG. 1B is a schematic diagram that shows a voxel and its neighbors in a 3-dimensional image arrangement.

FIG. 1C is a schematic block diagram that shows parts of a volume image processing apparatus according to an embodiment of the present invention.

FIG. 2A is a diagram that shows a representative volume image having eight slices.

FIG. 2B is a diagram that shows the slices of the volume image in FIG. 2A represented as tiles in a flat volume for GPU processing.

FIG. 2C is a diagram that shows an index variable k assignment for slices in the volume image, as used in a neighbor-order rendering scheme, according to an embodiment of the present invention.

FIGS. 2D, 2E, and 2F show the use of an index variable z for selecting the direction of referencing in neighbor-order rendering.

FIG. 3A is a logic flow diagram that shows the overall sequence of steps for processing a volume image using the graphics processing unit.

FIG. 3B is a logic flow diagram that shows the GPU data processing loop for current, preceding, and next slices.

FIG. 4 is a logic flow diagram that shows steps for obtaining the address of neighboring voxels.

FIG. 5 is a schematic diagram showing storage of a vector used for addressing.

FIG. 6 is a logic flow diagram that shows the sequence used for update of a voxel in neighbor-order rendering.

### DETAILED DESCRIPTION OF THE INVENTION

The following is a detailed description of the preferred embodiments of the invention, reference being made to the drawings in which the same reference numerals identify the same elements of structure in each of the several figures.

In the context of the present invention, the terms “tile” and slice are interchangeable. The term “texture” defines a variable-length data structure used in GPU data representation, familiar to those skilled in GPU programming.

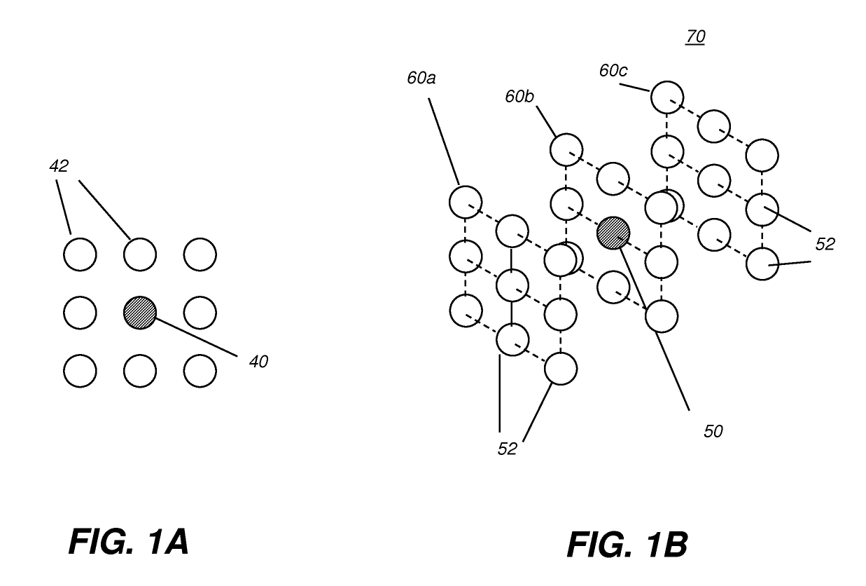

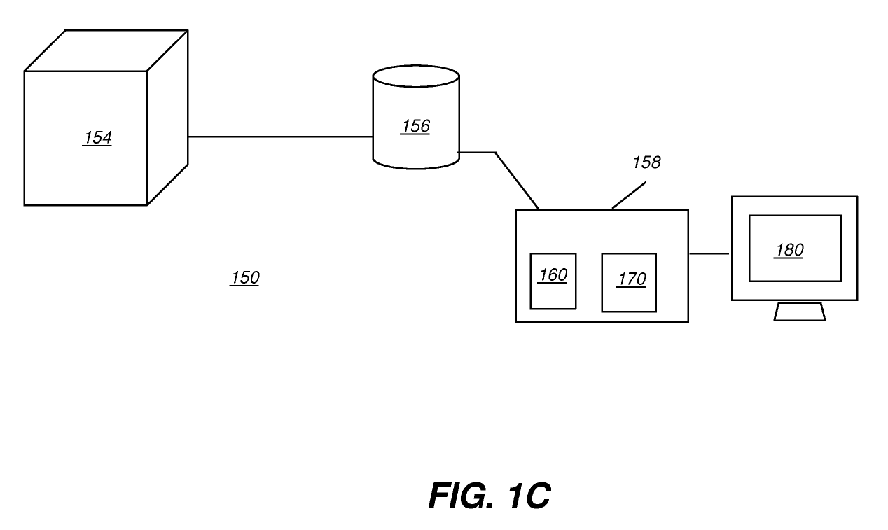

Segmentation, filtering, and other image processing functions for volume images typically require calculations that address each voxel and its surrounding neighbors or adjacent voxels. In 2D image processing, similar types of operations are carried out for individual pixels, with each individual pixel having 8 neighboring pixels. By way of reference, FIG. 1A shows a pixel 40 and its 8 neighboring pixels 42. For a volume image, as shown for reference in FIG. 1B, a neighborhood 70 is formed of adjacent voxels and spans multiple slices. In the example given in FIG. 1A, a voxel 50 has eight adjacent voxels in its corresponding slice 60b. A voxel 50 in a slice 60b has 26 neighboring or adjacent voxels 52. In the embodiment shown, adjacent neighboring voxels are those that are less than 2 times the distance of the nearest neighboring voxel, considered in any axial direction. In addition, it should be noted that some other fixed distance could be used to determine which voxels can be considered to be adjacent. For the FIG. 1A example, in addition to the eight voxels on its own slice 60b, nine additional voxels are adjacent on a preceding slice 60a; nine more voxels are similarly adjacent on a subsequent or next slice 60c. Given this added complexity with three dimensions, it can be appreciated that, because neighboring voxels are on different slices, voxel addressing becomes significantly more difficult than in the 2D case. This complexity increases when the fixed distance that defines adjacency is increased so that, for a subject voxel, more than 8 voxels are adjacent on its own slice 60b and more than 9 voxels are adjacent in neighboring slices 60a and 60c. In addition, this model can be expanded to further include voxels two tiles away in the previous and next directions, for example.

FIG. 1C is a schematic block diagram that shows parts of a volume image processing apparatus 150 according to an embodiment of the present invention. A volume imaging apparatus 154, such as a CT imaging apparatus, obtains the volume image of a patient or other subject. A computer-accessible memory 156 stores the obtained volume images for subsequent processing and display. A computer 158 accesses memory 156 in order to access and process the volume image data. Computer 158 has a control processing unit (CPU) 160 for handling overall logic and control functions. In addition, computer 158 also has a Graphics Processing Unit (GPU) 170 that provides improved processing for volume imaging. A display 180 is used to display the processing results for a medical practitioner or other viewer.

Embodiments of the present invention use the GPU 170 for high speed digital volume processing to support segmentation and other complex operations. A novel addressing scheme, termed neighbor-order rendering, allows quick access to data about neighboring voxels on different slices to facilitate the computation needed for segmentation and other compute-intensive volume image processing operations.

### Mapping Scheme

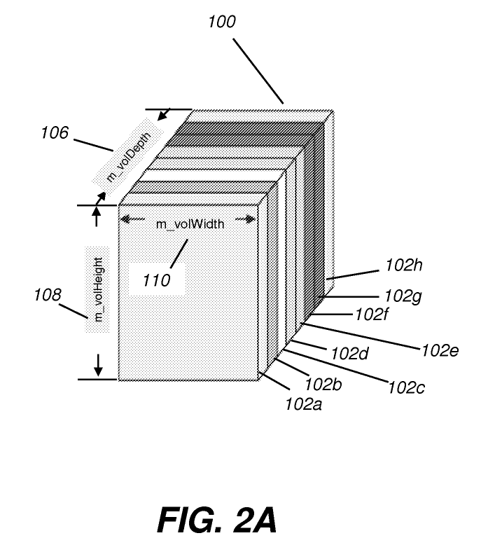

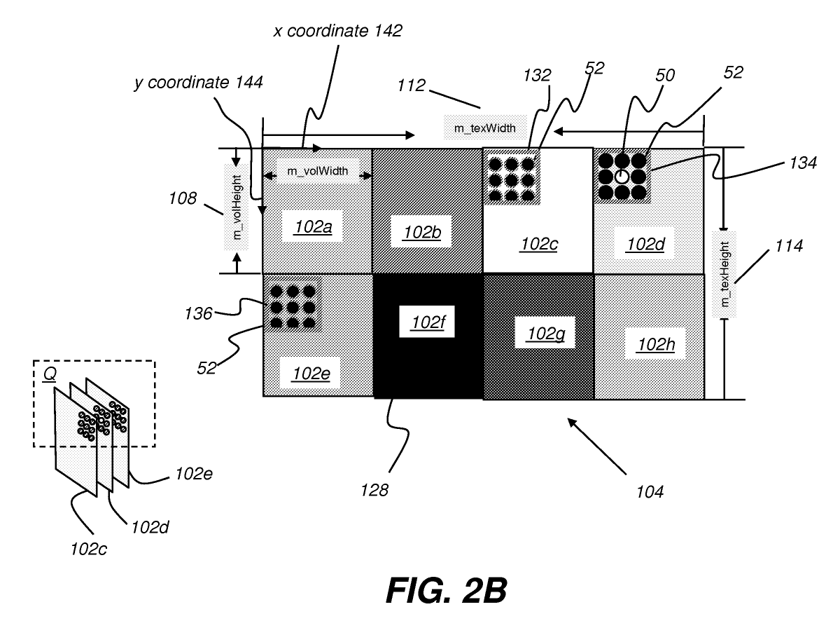

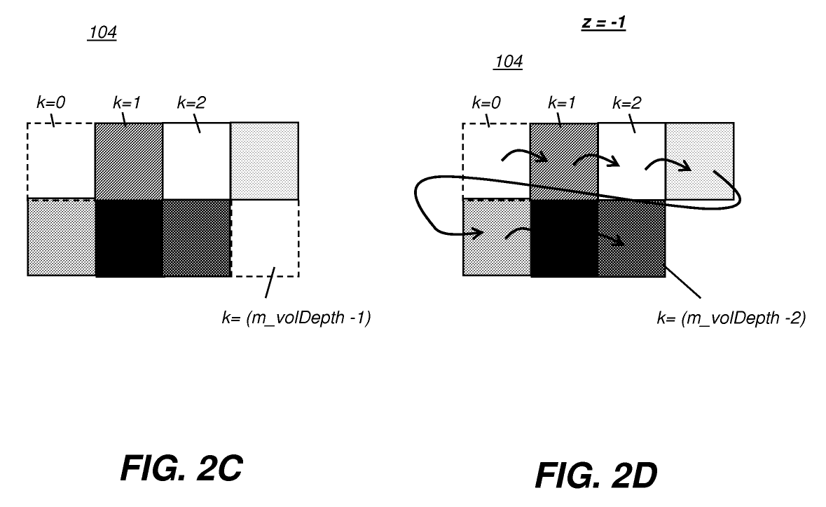

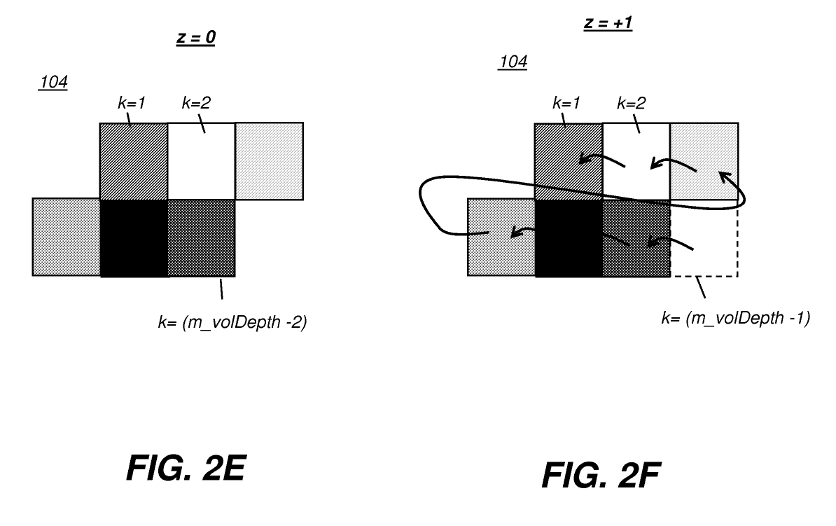

By way of illustration, FIG. 2A shows a simplified model volume 100 that has only eight slices, shown as 102a, 102b, 102c, 102d, 102e, 102f, 102g, 102h. Volume 100 has a depth 106, m_volDepth, with a value 8 that corresponds to the number of slices. Each slice has a height 108, m_volHeight, and a width 110, m_volWidth. Continuing with this eight-slice example, FIG. 2B shows how slices 102a-102h are mapped to a GPU data structure, as a flat volume or 2D texture 104. 2D texture 104 stores slices 102a-102h as “tiles”. This is a 1:1 ordered mapping, so that slice 1 maps to tile 1, slice 2 to maps to tile 2, and generally slice n maps to tile n. An inset Q shows how voxels in slices 102c, 102d, and 102e relate to each other spatially in a volume arrangement. The terms “slice” and “tile” are used equivalently herein to describe the same structure in the context of the present disclosure.

The use of a flat volume has been proposed for data representation in GPU processing in a number of different applications. One example application is described in the article “Simulation of Cloud Dynamics on Graphics Hardware” by Harris, Baxter, Scheuermann, Lastra, Proc. Graphics Hardware 2003, Eurographics Association, pp. 92-101. The use of a flat volume offers some advantages over more conventional 3D volume texture. For example, only one texture update is needed per operation and GPU parallelism is used efficiently. Schiwietz et al. '7131 also teaches a method of flat texture rendering for volume imaging. However, as noted earlier, it is necessary to calculate tile offsets in the flat volume in order to address neighbors for a voxel. This type of calculation is required for every voxel in the GPU shader program, requires multiple computations for update of each voxel, and can degrade shader performance.

In the flat volume or 2D texture of FIG. 2B, dimensions m_volWidth and m_volHeight are shown for slice 102a. A texture width 112 is shown as m_texWidth and is equal to:

m_texWidth=(m_volWidth)*(m_tileCol)

wherein m_tileCol is the number of tiles (slices in a row). In the current example, m_tileCol=4.

A texture height 114 is shown as m_texHeight. The texture height 112, denoted m_texHeight, of texture 104 equals:

m_texHeight=(m_volHeight)*(m_tileRow)

wherein m_tileRow is the number of rows of tiles in the 2D texture presentation. In the current example, m_tileRow=2.

To use the GrowCut algorithm or other type of processing using the mapped arrangement of FIG. 2B, an individual voxel's status (strength and label values) is updated based on its neighbors' status (strength and label values). As was shown in FIG. 1B, each voxel 50 has 26 neighboring voxels, including 9 voxels 52 on the preceding or previous slice and 9 voxels on the subsequent slice. In FIG. 2B, exemplary voxel 50 under consideration is shown as a white dot in a current slice 102d. The eight neighboring voxels 52 in that same slice are shown as dark dots in slice 102d and constitute a current neighborhood layer 134; with respect to FIG. 1B, these correspond to voxels 52 in slice 60b. The preceding or previous tile or slice 102c has nine neighboring voxels 52, also shown as dark dots. These voxels constitute a preceding neighborhood layer 132; with respect to FIG. 1B, these correspond to voxels 52 in slice 60a. The next tile or slice 102e similarly has nine neighboring voxels 52, also shown as dark dots. These constitute a next neighborhood layer 136; with respect to FIG. 1B, these correspond to voxels 52 in slice 60c.

As shown in FIG. 2B, there is a tile_x coordinate 142 and tile_y coordinate 144 that provide the coordinate axis system for the 2D texture 104. The origin is the upper left tile, slice 102a, in the 2D texture 104. For an arbitrary tile (or slice) in 2D texture 104, the tile_x and tile_y positions (or offset) for the tile can be computed as:

sliceX=k%m_tileCol

wherein sliceX is the starting tile_x coordinate for the tile, “%” is a modulus operator, and kε[0,m_volDepth−1];

sliceY=k/m_tileCol

where sliceY is the starting tile_y coordinate for said tile, “/” is an integer division operator (fractional component discarded), and kε[0,m_volDepth−1].

For the exemplary 8-tile (slice) flat volume of FIGS. 2A and 2B, m_volDepth=8. For an exemplary tile 128, k=5 and m_tileCol=4, therefore:

sliceX=5%4=1

sliceY=5/4=1

As shown in FIG. 2B, there is an x-y coordinate system (x coordinate 142, y coordinate 144) for the 2D texture 104, its origin is at the upper left corner of the 2D texture 104. For an arbitrary tile (or slice) in the 2D texture 104 shown in FIG. 2B, the starting x-y coordinate positions (or offset) for the tile can be computed as follows:

x1=sliceX*m_volWidth,

y1=sliceY*m_volHeight

wherein x1 is the starting x coordinate for a tile and y1 is the starting y coordinate for the tile.

FIGS. 2C, 2D, 2E, and 2F show how the flat volume mapping scheme of the present invention relates voxels in adjacent slices or tiles for rendering, and show how this scheme handles border conditions. For a pixel at a first coordinate in a subject tile, there is a next adjacent pixel at the same first coordinate in the next tile. Similarly, for a pixel at the first coordinate in a subject tile, there is a previous or preceding adjacent pixel at the same first coordinate in the preceding tile. In addition, these figures also show how variables described in subsequent processing steps are used. FIG. 2C shows how variable k is assigned for providing an index to each successive slice or tile. The first tile is assigned k=0 and is shown in dashed outline, since voxels within this tile are not rendered using neighbor-order rendering. This is also true for voxels in the last tile, which is assigned the value k=(m_volDepth-1).

The value z is used for indexing from a tile to its preceding and next tiles in neighbor-order rendering. FIG. 2D shows how preceding tiles are used in this rendering scheme. Here, first tile k=0 plays a part in rendering voxels in tile k=1. Voxels in tile k=1 are used to update voxels in tile k=2, and so on. The last tile is not used, since voxels in the k=(m_volDepth−1) tile are not rendered using this technique. FIG. 2E shows the case when z=0. Here, voxels in each of the tiles from k=1 through k=(m_volDepth−2) are updated using neighboring voxels within the same tile. FIG. 2F shows the case when index z=+1. Here, first tile k=0 plays no part in the rendering scheme, but last tile k=(m_volDepth−1) does, since data from each next tile is used for the current tile.

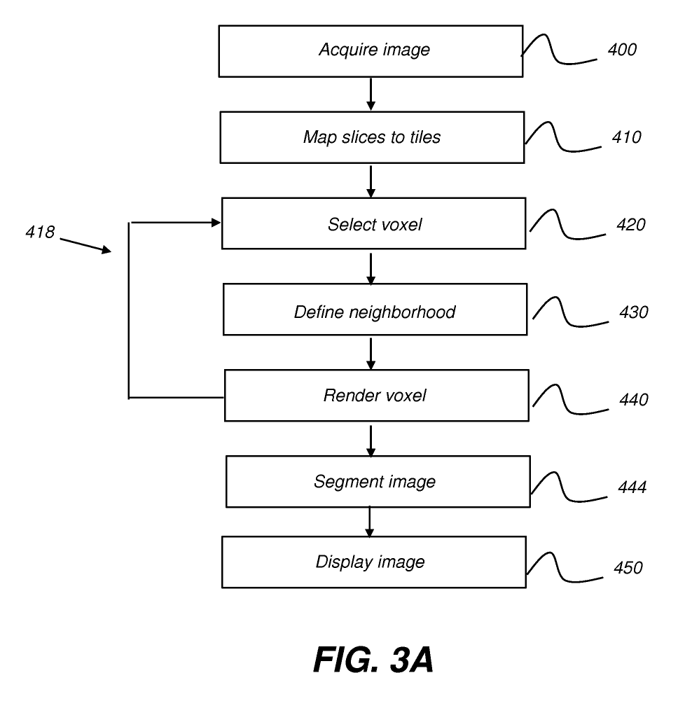

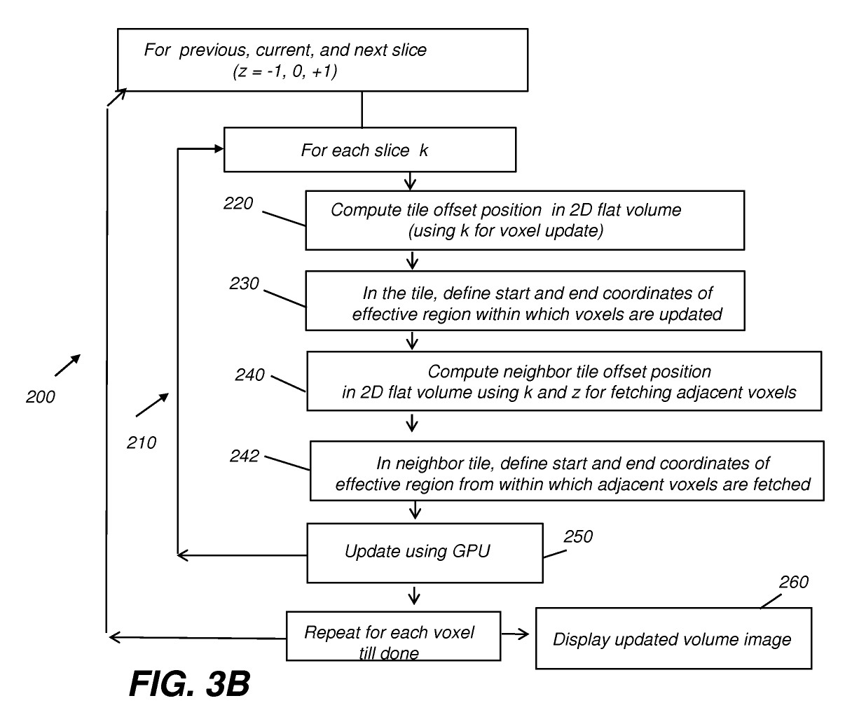

The logic flow diagram of FIG. 3A shows the overall sequence of steps for processing a volume image using the graphics processing unit. In an image acquisition step 400, the volume image data is acquired for processing. A mapping step 410 then forms a 1:1 mapping of the volume image data slices to corresponding tiles in the GPU digital flat volume. A loop 418 then executes for each voxel, with a voxel selection step 420 to specify the subject voxel for processing. A neighborhood definition step 430 defines the neighborhood that includes the subject voxel and adjacent voxels that are within the corresponding tile of the subject voxel, and adjacent voxels to the subject voxel that are within the preceding tile in the digital flat volume, and adjacent voxels to the subject voxel that are within the next tile in the digital flat volume. The subject voxel is then rendered (or updated) by fetching neighbor information in a rendering step 440 one layer (e.g., preceding neighborhood layer 132, current neighborhood layer 134, or next neighborhood layer 136) at a time. An optional segmentation step 444 can then be used to segment the image, using the GrowCut algorithm or other suitable segmentation algorithm. Finally, when all voxels have been suitably processed, the volume image is displayed in a display step 450.

Using the arrangement and definitions described with reference to FIGS. 2A through 2F, the logic flow diagram of FIG. 3B shows steps of a sequence that is used for addressing and processing each voxel in the volume image using GPU functions. In a first loop 200, preceding, current, and next index values, that is, the neighbor-order index z values, are successively assigned for handling voxel values in adjacent slices. As shown in FIG. 2D, value z=−1 is used as an index that corresponds to the preceding slice. As shown in FIG. 2E, index value z=0 corresponds to the current slice. As shown in FIG. 2F, index value z=+1 corresponds to the next slice. In an inner loop 210, each slice or tile is handled as part of the flat volume data structure described with reference to FIG. 2B.

By way of example, considering the FIG. 2B example for voxel 50 in slice 102d, when value z=−1, neighboring voxels 52 in slice 102c are used in processing. When z=0, voxels 52 in slice 102d are addressed. When z=1, voxels 52 in slice 102e are addressed.

Continuing with the FIG. 3B sequence, a step 220 computes the tile offset position for the tile to be rendered in the 2D flat volume, corresponding to its k value in FIG. 2C. A definition step 230 defines start and end coordinates of an effective region for the subject voxel within a tile in the 2D flat volume for processing. To prevent boundary conditions, the start and end coordinates are stepped back an increment from the edge of the tile. A computation step 240 computes the neighbor tile (proceeding, current or next) offset position using parameters k and z for fetching adjacent voxels. A computation step 242 defines start and end coordinates of an effective region in which adjacent voxels are fetched for the subject voxel. An update step 250 then calls GPU functions for updating voxel status. At the completion of the update process, a display step 260 displays the updated volume image.

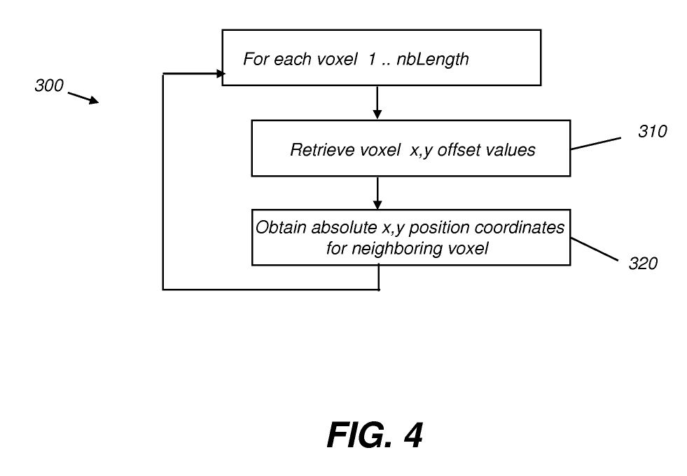

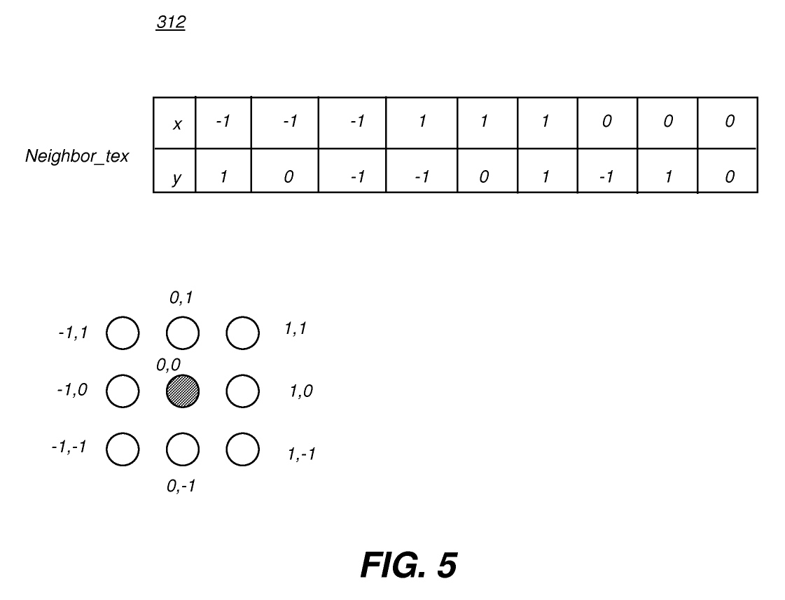

The logic flow diagram of FIG. 4 shows the voxel addressing sequence for neighbor-order rendering for each individual voxel 50 using the mapping of FIG. 2B, according to an embodiment of the present invention. A loop 300 executes for each neighboring voxel. Using the arrangement described previously with respect to FIG. 1B, the value nbLength equals 27, one for each of the neighboring voxels shown as 52 and one for voxel 50 itself. The 27 voxels in this example are from three layers, 9 voxels from the preceding neighborhood layer, 9 voxels from the current neighborhood layer, and 9 voxels from the next neighborhood layer. An offset retrieval step 310 retrieves the nine x and y offset values. These are stored as shown in the example of FIG. 5, in a texture 312. Absolute x- and y-position coordinates for each neighboring voxel are then obtained using the x and y offset values stored in a vector in a coordinate retrieval step 320. Coordinates for neighboring voxels are then simply obtained by adding the current voxel x,y coordinates to the x and y offset values.

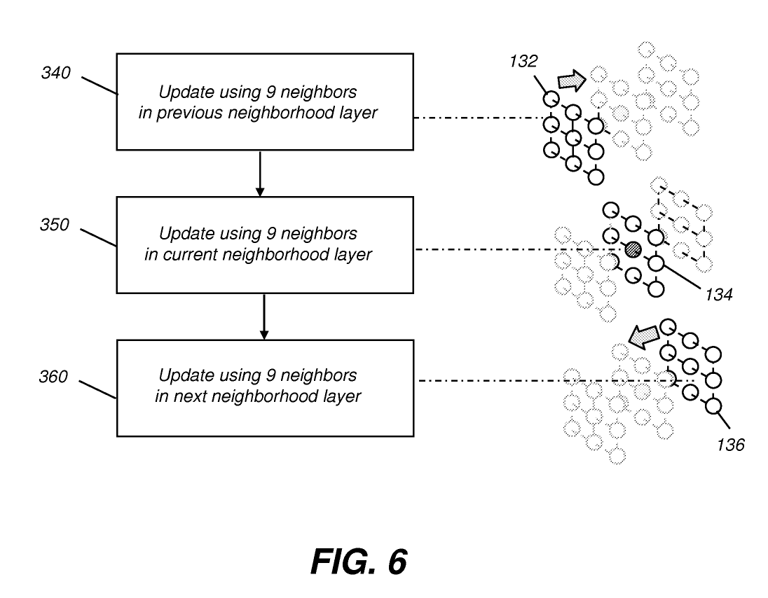

The block diagram of FIG. 6 shows three update steps 340, 350, and 360 for a voxel in graphic form. In a first update step 340, the voxel is processed using the 9 adjacent neighbor voxels in preceding neighborhood layer 132. In a second update step 350, the voxel is process using the 8 adjacent neighbor voxels in current neighborhood layer 134. In a third update step 360, the voxel is processed using the 9 adjacent neighbor voxels in next neighborhood layer 136.

This neighbor-order rendering approach is applied to voxels in all valid tiles one at a time in the flat volume. By way of example, the GrowCut algorithm employs five flat volumes (2D textures): one intensity texture, two label textures and two strength textures. All these 2D textures have the same basic tile arrangement.

As described with reference to FIGS. 2C-2F, not all voxels are located between preceding and next slices, such as voxels on the border of the volume image. For such voxels, the neighborhood may extend only one slice in a particular direction, since additional voxel data is not available in the alternate direction. In such a case, the neighborhood consists of voxels in the same tile as the selected voxel and in one neighboring tile.

Those skilled in the art can readily appreciate that the neighbor-order rendering approach described herein can be generalized for applications in which a voxel has a neighborhood of some size other than 3×3×3. In such a case, for the exemplary GrowCut algorithm, a voxel's status (strength and label values) is updated based on its neighbors' status (strength and label values) in a plurality of steps by splitting its neighborhood into a plurality two dimensional neighborhood layers (or, simply, layers), namely, preceding or previous layers, current layer, and following layers residing in the preceding tiles, current tile and following tiles respectively.

Convergence verification is done by occlusion query. Two 2D label textures are compared and voxels in corresponding positions in two textures are discarded if they have identical label values. The occlusion query returns the number of remaining voxels in a label texture. The GrowCut evolution process (iteration) is terminated if the number returned is zero, which means that propagation process has converged.

It can be appreciated that the data mapping and addressing scheme of the present invention, using the GPU flat volume representation, facilitates addressing of voxels in adjacent slices, thus simplifying the update processing task for each voxel. Using the GPU to perform this function provides significant advantages for processing throughput, helping to speed execution of the GrowCut algorithm and similar processing.

The present invention is described as a method. However, in another embodiment, the present invention comprises a computer program product for image linear structure detection in medical applications in accordance with the method described. In describing the present invention, it should be apparent that the computer program of the present invention can be utilized by any well-known computer system, such as the personal computer. However, many other types of computer systems can be used to execute the computer program of the present invention.

It will be understood that the computer program product of the present invention may make use of image manipulation algorithms and processes that are well known. Accordingly, the present description is directed in particular to those algorithms and processes forming part of, or cooperating more directly with, the method of the present invention. Thus, it will be understood that the computer program product embodiment of the present invention may embody algorithms and processes not specifically shown or described herein that are useful for implementation. Such algorithms and processes are conventional and within the ordinary skill in the image processing art. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

Processing results from methods and apparatus of the present invention can be displayed on a control monitor, for example, or can be reported to a viewer or provided, as data, for subsequent image processing and analysis. Linear structures and microcalcifications that are detected by the method of the present invention can be highlighted on the display, for example.

A computer program product may include one or more storage media, for example; magnetic storage media such as magnetic disk or tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention. The computer of the present invention has both a central processing unit (CPU) and a Graphics Processing Unit (GPU) that cooperate to provide the volume processing functions described herein.

It will be appreciated that variations and modifications can be effected by a person of ordinary skill in the art without departing from the scope of the invention. The subject matter of the present invention relates to digital image processing and computer vision technologies, which is understood to mean technologies that digitally process a digital image to recognize and thereby assign useful meaning to human understandable objects, attributes or conditions, and then to utilize the results obtained in the further processing of the digital image.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for processing a digital volume image, executed at least in part on a computer, comprising:
receiving the digital volume image as a stack of image slices, each slice including a plurality of voxels;
forming a 1:1 mapping of each of the slices, in order, to a corresponding tile in a digital flat volume;
defining, for at least one voxel in a plurality of voxels in the digital flat volume, a neighborhood that comprises the at least one voxel and adjacent voxels that are within the corresponding tile of the at least one voxel, and adjacent voxels to the at least one voxel that are within the preceding tile in the digital flat volume, and adjacent voxels to the at least one voxel that are within the next tile in the digital flat volume;
rendering the at least one voxel according to the adjacent voxels in its defined neighborhood; and
displaying the volume image having the at least one rendered voxel.

2. The method of claim 1 wherein rendering the at least one voxel comprises processing the at least one voxel using a graphics processing unit.

3. The method of claim 2 wherein the digital flat volume is a two-dimensional texture of the graphics processing unit.

4. The method of claim 1 wherein receiving the digital volume image comprises receiving a computerized tomography image.

5. The method of claim 1 wherein the at least one voxel has 8 adjacent voxels in its corresponding tile.

6. The method of claim 1 further comprising segmenting the volume image.

7. A method for processing a volume image using a graphics processing unit, comprising:
receiving the volume image that is formed as a stack of image slices, each slice including a plurality of voxels;
forming a 1:1 mapping of each of the slices, in order, to a corresponding tile in a digital flat volume;
defining, for at least one voxel in a plurality of voxels in the digital flat volume, a neighborhood that comprises the at least one voxel and adjacent voxels that are within the corresponding tile of the at least one voxel, and adjacent voxels to the at least one voxel that are within the preceding tile in the digital flat volume, and adjacent voxels to the at least one voxel that are within the next tile in the digital flat volume;
rendering the at least one voxel according to the adjacent voxels in its defined neighborhood;
segmenting the volume image having the at least one rendered voxel; and
displaying the segmented image.

8. The method of claim 7 wherein the digital flat volume is a two-dimensional texture of the graphics processing unit.

9. The method of claim 7 wherein receiving the digital volume image comprises receiving a computerized tomography image.

10. The method of claim 7 wherein the at least one voxel has 8 adjacent voxels in its corresponding tile and nine adjacent voxels in each of the preceding and next tiles.

11. A method for processing a computerized tomography volume image using a graphics processing unit, comprising:
receiving the computerized tomography volume image that is formed as a stack of image slices, each slice containing a plurality of voxels;
forming a 1:1 mapping of each of the slices, in order, to a corresponding tile in a digital flat volume;
defining, for at least one voxel in a plurality of voxels in the digital flat volume, a neighborhood that comprises the at least one voxel at a first coordinate and its adjacent voxels that are within the corresponding tile of the at least one voxel, and a preceding adjacent voxel at the first coordinate within the preceding tile in the digital flat volume and its adjacent voxels that are within the preceding tile, and a next adjacent voxel at the first coordinate within the next tile in the digital flat volume and its adjacent voxels that are within the next tile;
updating the at least one voxel according to the adjacent voxels in its defined neighborhood;
segmenting the volume image having the at least one rendered voxel; and
displaying the segmented image.
